(19) United States
(12) Patent Application Publication
(10) Pub. No.: US 2021/0354331 A1
(43) Pub. Date: Nov. 18, 2021

(54) MACHINING CENTER FOR CUTTING OBJECTS

(71) Applicant: C.M.S. S.p.A., Zogno (IT)

(72) Inventor: Lorenzo MOTTERLINI, Palazzago (IT)

(21) Appl. No.: 17/314,460

(22) Filed: May 7, 2021

(30) Foreign Application Priority Data
May 13, 2020 (IT) 102020000010936

(51) Int. Cl. B28D 7/00; B28D 1/04

(52) U.S. Cl. CPC B28D 7/00; B28D 1/04

(57) ABSTRACT

A machining centre is disclosed for cutting an object in the form of a slab including a support plane arranged to support the object, a machining unit provided with a cutting tool that is rotatable to cut the object, and with a fluid jet cutting device that is also drivable to cut the object; the machining unit is movable with respect to the support plane along a first axis, a second axis and a third axis of a triad of orthogonal axes to move the cutting tool and the fluid jet cutting device to/from said support plane, the machining unit is further rotatable about a first rotation axis to rotate the cutting tool and the fluid jet cutting device with respect to the support plane; the machining unit is provided with a handling device arranged to support and to move the fluid jet cutting device with respect to the fluid jet cutting device at least along a direction that is transverse to the first axis of rotation.

### BACKGROUND OF THE INVENTION

The invention relates to a machining centre for cutting objects.

Specifically, but not exclusively, the invention relates to a numerically controlled machining centre, for example with five controlled axes, for cutting objects in the form of a slab, in particular objects made of ceramic, metal, glass, stone or similar material.

Numerically controlled machining centres with controlled axes are known that are arranged for cutting a stone, glass, ceramic, or metal slab. The machining centres include a frame arranged to bound a cutting area in which the slab is cut. The slab is rested in the cutting area, with the prevailing dimension of the slab oriented parallel to a support plane on which the machining centre rests. The frame has the form of a portal, i.e. includes two vertical support elements and a crosspiece oriented perpendicularly to the vertical support elements. The crosspiece slides on a guide surface obtained on the vertical support elements along a first substantially horizontal sliding direction, i.e. oriented parallel to the support plane. The machining centre includes a handling unit fitted to the crosspiece and slidable along a second sliding direction substantially horizontal and perpendicular to the first sliding direction. A machining unit 100, shown in detail in FIG. 1, is fitted to the handling unit. The machining unit 100 includes a cutting arrangement arranged to perform cutting tasks on a slab object that is not shown, in particular a cutting disc 102 and a cutting nozzle 103. The cutting disc 102 can be rotated to cut the object along a cutting direction 106. The cutting nozzle 103 is substantially aligned on the cutting tool 102 along the cutting direction 106. The cutting nozzle 103 is drivable to dispense a water jet, mixed with abrasive powder, at high speed/pressure to cut the object/the slab in the cutting area along the cutting direction 106. The machining unit 100 is movable towards and away from the object along an approach/distancing direction 104 to move the cutting disc 102 and the cutting nozzle 103 towards and away from the object. The machining unit 100 is rotable around a first axis of rotation 104a to rotate the cutting disc 102 and the cutting nozzle 103 with respect to the object that has to be cut. The first axis of rotation 104a is substantially parallel to the direction 104. The machining unit is further rotatable around a second axis of rotation 101, oriented transversely to the first axis of rotation 104a, as shown in FIG. 1, to vary the angular position of the cutting disc 102 and of the cutting nozzle 103 with respect to the support plane of the machining centre, for example to tilt the angular position of the cutting disc 102 and of the cutting nozzle 103 with respect to the support plane where the object to be cut rests. The cutting nozzle 103 and the cutting disc 102 are driven alternating with one another, i.e. a slab can be cut either by driving the cutting disc or by actuating the cutting nozzle. The cutting nozzle 103 is further movable in a further approach/removal direction 105, parallel to the approach/removal direction 104 or to the first axis of rotation 104a, independently of the movement along the approach/removal direction 104 of the machining unit 100.

Various aspects of these prior-art machining centres are improvable. Considering a triad of Cartesian axes, X, Y, Z, shown in FIG. 1, the cutting nozzle 103 has a single degree of freedom (along the Y axis), being movable only in the approach/removal direction 104 and in the further approach/removal direction 105. In other words, considering a plan V, parallel to the plane Y-Z, and to which the cutting disc 102 and the cutting nozzle 103 belong, the distance between the cutting nozzle 103 and the cutting disc 102 along the cutting nozzle 106 remains fixed. The same reasoning applies to another plan parallel to the plane X-Z. The impossibility of varying the corresponding position between the cutting nozzle 103 and the cutting disc 102 significantly limits the cutting area of the cutting nozzle 103 during the cutting operations and subordinates the movements of the cutting nozzle 103 to the dimensions and to the movements of the cutting disc 102. In order to compensate for this limit, in these machining centres it is necessary to increase further the overall dimensions and the distance between the nozzle and disc. The weight of the machining unit thus increases, thus making the operation of controlling the movements of the machining unit more complex, for example the speed, acceleration and deceleration of the movements thereof on supporting elements (vertical support elements, crosspiece and carriage for example). The cutting operations are thus hardly precise. Further, it is often requested to increase the value of the stroke of the machining unit, in addition to increasing the dimensions to enable the machining unit to be tilted with respect to the support plane so that the cutting nozzle performs a tilted cutting operation on the slab. As a result, also the dimensions of the supporting elements of the machining unit have to be increased, this resulting in an increase in the total weight of the machining centre.

Machining centres are further known that are identical structurally and operationally to the machining centres that have just been disclosed but with the only difference that the cutting nozzle is misaligned with respect to the cutting disc.

Such machining centres have the same disadvantages as those disclosed previously, which will not be repeated again.

### SUMMARY OF THE INVENTION

One object of the invention is to improve known machining centres for cutting objects, in particular the machining centres for cutting objects in the form of a slab.

One object of the invention is to increase the machining area of a fluid jet cutting device containing the overall dimensions, the dimensions and the strokes of a machining unit of the machining centre.

One advantage is to provide a machining centre that is constructionally compact and easy to make.

One advantage is to reduce the overall dimensions, dimensions and the strokes of the machining unit.

Once advantage is to control easily and precisely the movements of the machining unit and the cutting operations performed on the object.

One advantage is to increase the degrees of liberty of the fluid jet cutting device.

One advantage is to provide a machining unit that includes a fluid jet cutting device provided with a pressurized fluid distribution set that rotates and has relatively reduced dimensions.

These objects and advantages and still others are all reached by the machining centre according to one of more of the claims set out below.

In one embodiment, a machining centre configured for cutting an object in the form of a slab includes a support plane arranged to support the object and a machining unit provided with a cutting tool that is rotatable to cut the object and with a fluid jet cutting device that is also drivable to cut the object. The machining unit is movable with respect to the support plane along a first, a second and a third axis of a triad of orthogonal axes Y, Z, X to move the cutting tool and the fluid jet cutting device towards/from the support plane. The machining unit is further rotatable around a first axis of rotation to rotate the cutting tool and the fluid jet cutting device with respect to the support plane. The machining unit is further provided with a handling device arranged to support and to move the fluid jet cutting device with respect to the machining unit at least along a horizontal direction, i.e. a direction that is transverse to the first axis of rotation.

### BRIEF DESCRIPTION OF THE DRAWINGS

The invention can be better understood and implemented with reference to the attached drawings that illustrate an example thereof by way of non-limiting example, in which:

FIG. 1 shows a machining unit included in a machining centre for cutting products in the form of a slab found in the prior art;

FIG. 2 is a machining centre for cutting products in the form of a slab according to the invention;

FIG. 3 shows an enlarged detail of a machining unit provided in the machining centre of FIG. 2;

FIG. 4 is a perspective view of a rotating joint provided in the machining unit of FIG. 3;

FIG. 5 is a section view of the rotating joint of FIG. 4;

FIGS. 6A-6D show the steps of moving the fluid jet cutting device from a first position to a second position;

FIG. 7A is a perspective view of the machining unit of FIG. 3 in which the fluid jet cutting device adopts a first raised position;

FIG. 7B is a side view of FIG. 7A;

. 8A is a perspective view of the machining unit of FIG. 3 in which the fluid jet cutting device adopts a first lowered position;

FIG. 8B is a side view of FIG. 8A;

FIG. 9A is a perspective view of the machining unit of FIG. 3 in which the fluid jet cutting device adopts a second position;

FIG. 9B is a side view of FIG. 9A;

FIG. 10A is a perspective view of the machining unit of FIG. 3 in a tilted position in which the fluid jet cutting device adopts a second raised position;

FIG. 10B is a side view of FIG. 10A;

FIG. 11A is a perspective view of the machining unit of FIG. 3 in a tilted position in which the fluid jet cutting device adopts a second lowered position;

FIG. 11B is a side view of FIG. 11A;

FIG. 12A is a version for using the machining unit in which this machining unit adopts a position for performing drilling and milling tasks and the fluid jet cutting device adopts a first position;

FIG. 12B is a side view of FIG. 12A.

### DETAILED DESCRIPTION

With reference to the aforesaid figures, a machining centre has been indicated overall with the numeric reference 1 that is configured for cutting objects, for example objects in the form of a slab.

The objects in the form of a slab, which are not shown in the figures, can be made of ceramic, metal, vitreous, stone or other similar materials. The objects in the form of a slab can have a first dimension (for example a width) included between 2 cm and 230 cm, a second dimension (for example a length) included between 2 cm and 4000 cm and a third dimension (for example a thickness) included between 2 mm and 200 mm.

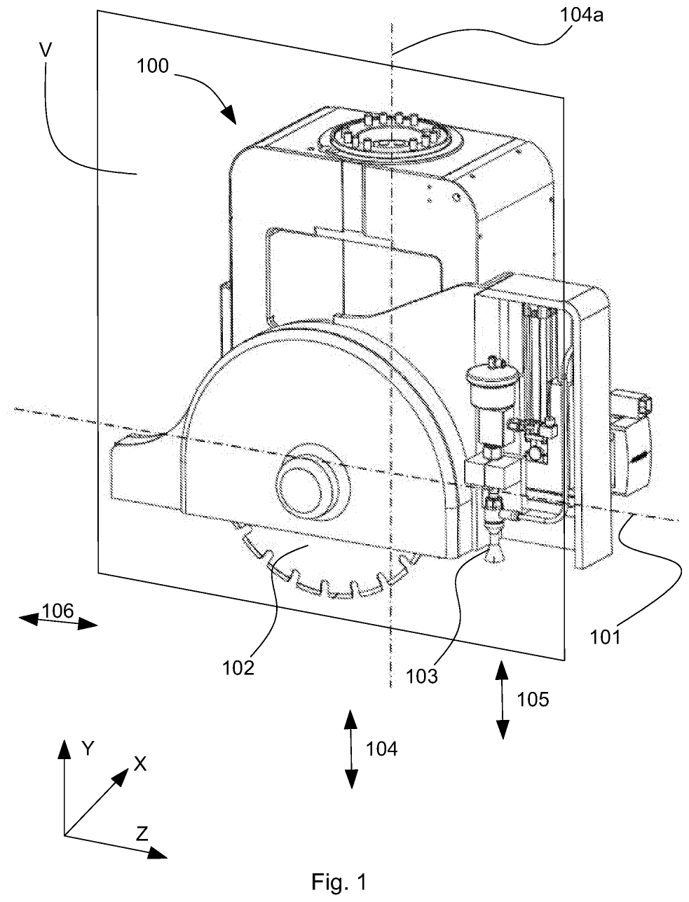

The machining centre 1 can be a machining centre with five controlled axes. The machining centre 1 can be a numeric control machining centre 1, for example provided with a control unit 7, configured for controlling the driving of the cutting operations that will be disclosed below. The control unit 7 is shown in FIG. 1, and is integrated for example into the machining centre 1.

The control unit 7 can be provided with a control keyboard by means of which an operator can set the tasks the machining centre has to perform on the object, and with a display that is suitable for showing the operator warning or control messages.

The machining centre 1 includes a support plane 2 that is suitable for supporting the object that has to be cut. The support plane 2 extends mainly parallel to two axes X, Z of a triad of orthogonal axes Y, Z, X. The support plane 2 defines a machining area, or also known as a cutting area, i.e. an area in which the object is subjected to operations of different types, for example cuts performed by a cutting device.

The support plane 2 can include a metal grille on which the object is rested. The metal grille can cover a tank filled with a fluid, for example with water. The metal grille can be in turn covered with a sacrificial material to prevent incisions and wear to the metal grille during the cutting operations. The sacrificial material can include wooden tables or elements made of plastics or rubber material.

Locking elements of known and not illustrated type can also be provided that is arranged to lock the object to be cut on the support plane 2 and keep the object still during the cutting operations.

The machining centre 1 can have a portal structure. In other words, the machining centre 1 can be provided with a support frame including two support elements 8 and a crosspiece 9 fitted to the two support elements 8 and oriented transversely to the latter. The support elements 8 extend mainly parallel to the Y axis, known below first axis Y. The crosspiece 9 extends mainly parallel to the Z axis, known below as the second axis Z.

The crosspiece 9 is positioned operationally above the support plane.

The machining centre 1 further includes a carriage 10 fitted slidingly to the crosspiece 9; to the carriage 10, a machining unit 3 is connected that is provided with a cutting device that is drivable to cut the object on the support plane 2.

The cutting device can include a cutting tool 4 that is rotatable to cut the object, and a fluid jet cutting device 5 that is also drivable to cut the object by dispensing a jet of pressurized water to which abrasive powder has been added.

The cutting tool 4 can be drivable alternatively to the fluid jet cutting device 5; in other words a cutting task can be performed on the object with the cutting tool, or alternatively with the fluid jet cutting device.

The machining unit 3 movable with respect to the support plane 2 along the first axis Y, along the second axis Z and along the axis X, known below as the third axis X. In this manner the machining unit 3 is able to move the cutting tool 4 and fluid jet cutting device 5 towards/away from the object to be cut, i.e. towards/away from the support plane 2.

For example, on each of the support elements 8 a guide (not shown) can be obtained extending parallel to the first axis Y to enable the crosspiece 9 to slide parallel to the first axis Y. Also, on each of the support elements 8 a second guide (not shown) can be obtained extending parallel to the third axis X to enable the crosspiece 9 to slide parallel to the third axis Y. Further, the carriage 10 can slide on the crosspiece 9 parallel to the second axis Z. The movements of the crosspiece 9 and of the carriage 10 consequently make also the machining unit 3 movable.

Other design configurations can obviously be provided to enable the machining unit to be movable along the three axes, for example providing on the carriage 10 (and not on the support elements 8) a guide extending along the first axis Y to enable the machining unit 3 to slide along said guide, and so on.

Obviously, an actuating device is provided (appropriately connected to the crosspiece, or to the carriage or to the machining unit) that is drivable to move the machining unit 3 (i.e. the crosspiece and the carriage) with respect to the support plane 2.

The machining unit 3 is further rotatable around a first axis of rotation R to rotate the cutting tool 4 and the fluid jet cutting device 5 with respect to the object to be cut, i.e. with respect to the support plane 2. The machining unit 3 is connected to a drivable motor to rotate the machining unit 3 around the first axis of rotation R.

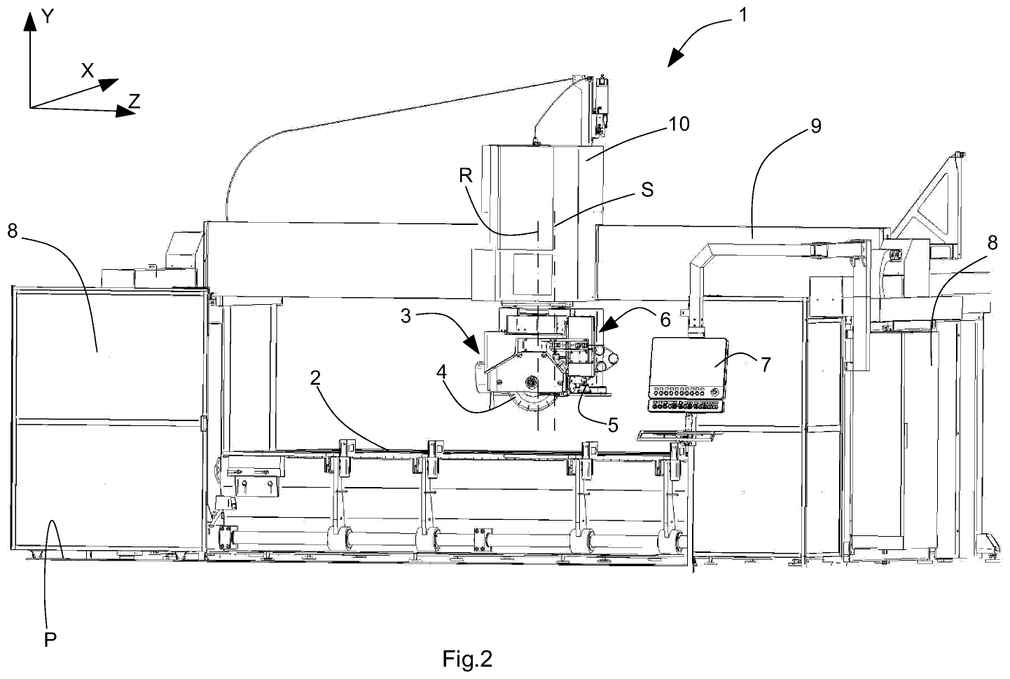

In FIG. 2, the axis of rotation R (in one operating step) is oriented transversely to the support plane 2, or is substantially parallel to the first axis Y.

The machining unit 3 is also provided with a suction cup element 14, arranged to adhere to a surface of the object by exploiting a vacuum status therewithin. The suction cup element 14 can adhere to a surface of the object and enable, for example, the machining unit 3 to move the suction cup element 14 with respect to the support plane 2.

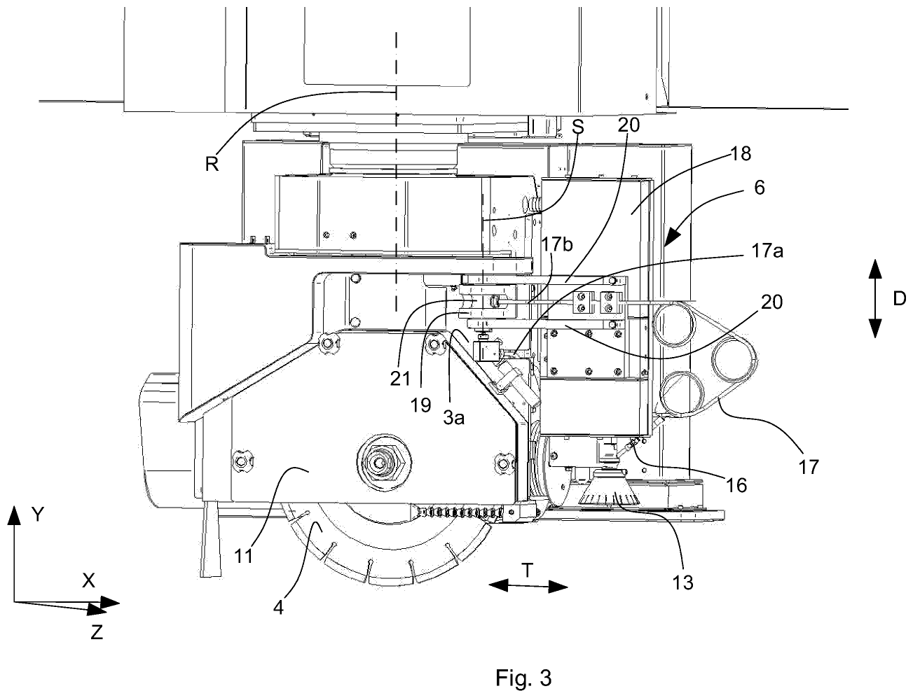

The cutting tool 4 can be a cutting disc including a core made of steel and a perimeter diamond-tipped rim. The cutting tool 4 is rotatable around a rotation axis Q to cut the object along a cutting direction T, shown in FIG. 3.

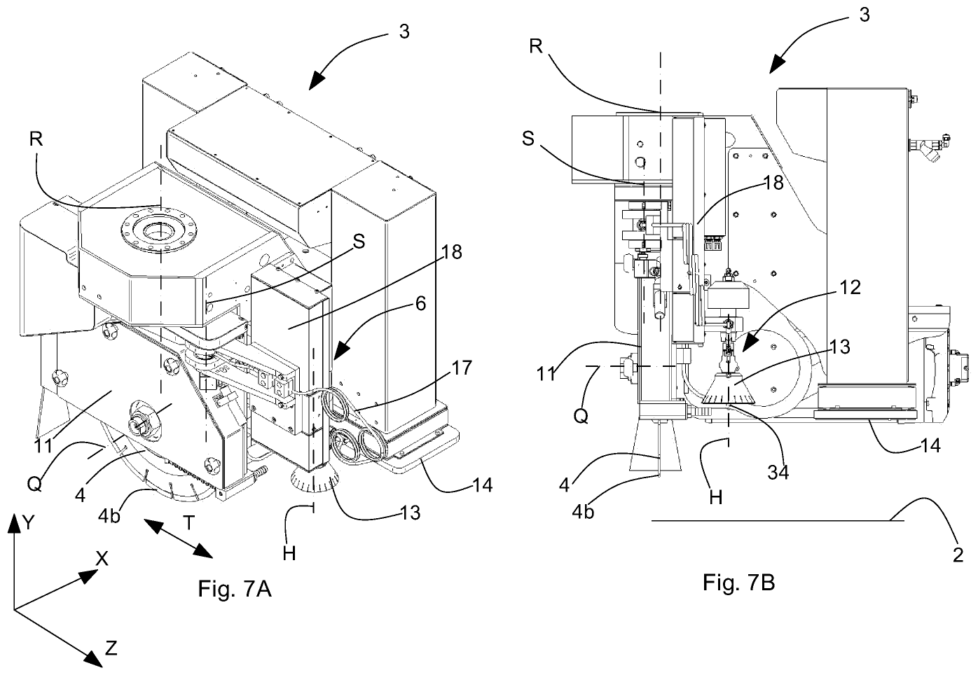

The cutting tool 4 can include a cutting edge, for example the side edge of the disc. With reference to 4b, in particular in FIGS. 7A, 7B, 8A, 8B, 9A, 9B, a portion of cutting edge has been shown that (in a given moment of time) is intended to interact with a surface of the object to cut the surface, when the cutting tool 4 is rotated.

The cutting tool 4 can be connected to a servospindle, which is not shown, that is drivable to rotate the aforesaid cutting tool 4. The servospindle can be provided with an inverter to vary continuously the rotation speed of the cutting tool 4. With the cutting tool 4, a laser cursor can be possibly associated that is arranged to display the cutting direction T. With the cutting tool 4, a protective housing 11 can be further associated arranged for preventing possible chips that could become detached from the workpiece from being projected outside the cutting area and hitting an operator.

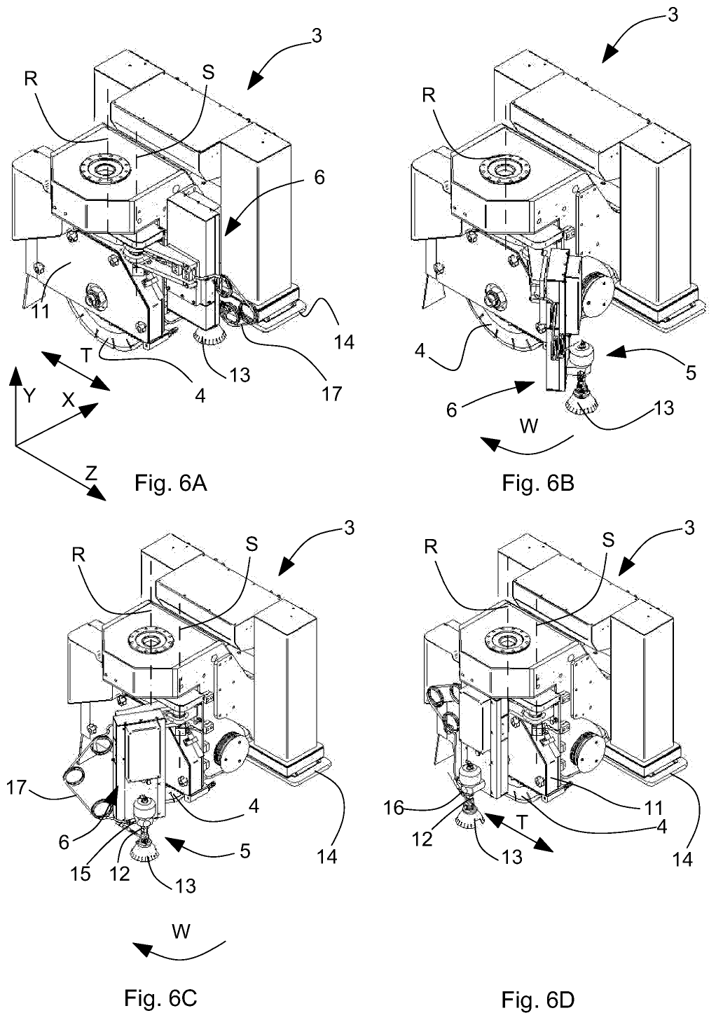

The fluid jet cutting device 5 can include a cutting head 12 configured for dispensing a water jet onto the object to be cut. The cutting head 12 can include an inlet 15 arranged to receive a flow of pressurized water, shown in FIG. 6C, and an accelerating nozzle, which is not shown in detail, shaped for receiving the pressurized water from the inlet 15 and to accelerate the flow of water by transforming the energy of the pressurized water into kinetic energy. The cutting head 12 can include another inlet 16, shown in FIG. 6D, for receiving the abrasive powder, a mixing chamber not shown shaped for receiving the flow of water exiting the accelerating nozzle and the abrasive powder and enabling mixing thereof.

The cutting head 12 can include a dispensing nozzle 34 sized for dispensing onto the object to be cut the jet formed by the mixture of water and abrasive powders. With the dispensing nozzle 34, a containing casing 13 is associated that is arranged to contain the sprays of the jet.

The fluid jet cutting device 5 is connected to a pressurized water generating device that is not shown, for example an electric or hydraulic pressure identifier. The pressurized water generating device is configured for dispensing pressurized water to the fluid jet cutting device 5 and is placed in fluid connection with the fluid jet cutting device 5, in particular with the inlet 15 of the cutting head 12, by a plurality of tubes 17. The tubes 17 can be made of flexible, metal or synthetic rubber material, which are materials that are suitable for supporting medium and high water pressure that circulates therein, for example water pressure also above 4000 bar.

The fluid jet cutting device 5 is further connected to a tank of abrasive powders that is not shown, for example a doser of abrasive powders. The doser is placed in contact with the fluid jet cutting device 5, in particular with the other inlet 16 of the cutting head 12, by another tube that is not shown, which is also made of flexible material.

The fluid jet cutting device 5 is arranged to dispense an abrasive water jet according to an operating axis H, shown in FIGS. 7A to 9B.

The machining unit 3 is provided with a handling device 6 arranged to support the fluid jet cutting device 5. In other words, the fluid jet cutting device 5 is fitted to the handling device 6.

The handling device 6 is also arranged to move the fluid jet cutting device 5 with respect to the cutting tool 4 rotating along at least a direction that is transverse to the first axis of rotation R.

The handling device 6 is arranged to move the fluid jet cutting device 5 between a first position in which the operating axis H of the fluid jet cutting device 5 is placed at a first distance from the axis of rotation Q of the cutting tool 4, and a second position in which the operating axis H of the fluid jet cutting device 5 is placed at a second distance from the axis of rotation Q of the cutting tool 4, the second distance being less than the first distance.

For example, in one embodiment that is not shown in which the fluid jet cutting device is not aligned on the cutting tool along the cutting direction of the cutting tool, the handling device is arranged to translate the fluid jet cutting device between the first and the second position along at least a direction that is transverse to the axis of rotation of the machining unit. On the basis of the overall dimensions of the machining unit, of the fluid jet cutting device and of the cutting tool, the translation of the fluid jet cutting device can occur either along a direction substantially parallel to the cutting direction of the cutting tool, or along two directions, a direction substantially parallel to the cutting direction of the cutting tool and a direction substantially orthogonal, on the plane, to this cutting direction.

In another embodiment that is not shown in which the fluid jet cutting device is aligned with the cutting tool along the cutting direction of this cutting tool, the handling device is arranged to translate the fluid jet cutting device between the first and the second position along a direction substantially parallel to the cutting direction of the cutting tool and a direction substantially orthogonal, on the plane, to this cutting direction.

In both embodiments, which are not shown, the handling device is arranged to move the cutting device to said fluid also along a direction parallel to the first axis of rotation of the machining unit.

In the embodiments shown in the attached figures, the handling device 6 is arranged to rotate the fluid jet cutting device 5 around a second axis of rotation S between the first position and the second position independently of the rotation impressed on the fluid jet cutting device 5 by the rotation of the machining unit 3 around the axis of rotation

R.

In one operating step, the second axis of rotation S can be substantially parallel to the first axis of rotation R.

The fluid jet cutting device 5 can perform a cutting task on the object both in the first and in the second position. In the first position, the device 5 the distance between the operating axis H and the axis of rotation Q is greater than the distance between the operating axis H and the axis of rotation Q in the second position.

In order to be clearer, considering FIGS. 6A-6D and 7A to 9B, an observer positioned in the plane Y-Z and who observes the machining unit 3 looking along the axis X, would notice that in the first position the fluid jet cutting device 5 occupies a machining area that is substantially behind the cutting direction T of the cutting tool 4, whilst in the second position the fluid jet cutting device 5 occupies a machining area in front of the cutting direction T. The machining area is in front of the rear machining area with reference to the cutting direction T.

The handling device 6 is configured to move the fluid jet cutting device 5 around the second axis of rotation S by an angle included between 90° and 200°, or included between 120° and 200°, or between 150° and 190°, in particular by an angle 180°. The rotation of the fluid jet cutting device 5 occurs in a rotation direction W, for example a clockwise rotation direction, or along another rotation direction that is not shown, opposite the direction W, for example anticlockwise. The steps of the movement from the first position to the second position of the fluid jet cutting device are shown in FIGS. 6A-6D.

In one embodiment that is not shown however, in the first position the fluid jet cutting device 5 can be substantially aligned with the cutting tool 4 along the cutting direction T. In this case obviously, the handling device is configured to move the fluid jet cutting device 5 around the second axis of rotation S by an angle of substantially 90°.

The handling device 6 is also shaped to enable the fluid jet cutting device 5 to move along a movement direction D to move the fluid jet cutting device 5 towards/away from the object independently of a movement towards/away from impressed on the fluid jet cutting device 5 by a movement of the machining unit 3. The movement direction D is substantially parallel to the second axis of rotation S. When the second axis of rotation S is substantially parallel to first axis of rotation R, then the movement direction D is also substantially parallel to this last axis of rotation R.

The handling device 6 can include a slide 18 arranged for supporting the fluid jet cutting device 5. On the slide 18, a guide can be provided extending parallel to the movement direction D; the fluid jet cutting device 5 can be fitted slidingly to this guide to move along this movement direction D. An actuating device, of known type, can be provided that is drivable to move the cutting device to said fluid 5, in particular the cutting head 12, along the movement direction D.

The handling device 6 can further include a supporting bracket 19 arranged to support rotatingly the slide 18 around the second axis of rotation S, as explained below.

The supporting bracket 19 can be connected removably on a face 3a of the machining unit 3. The supporting bracket 19 can be connected by threaded connecting elements of known type, for example screws or bolts. The supporting bracket 19 can be of the fork type.

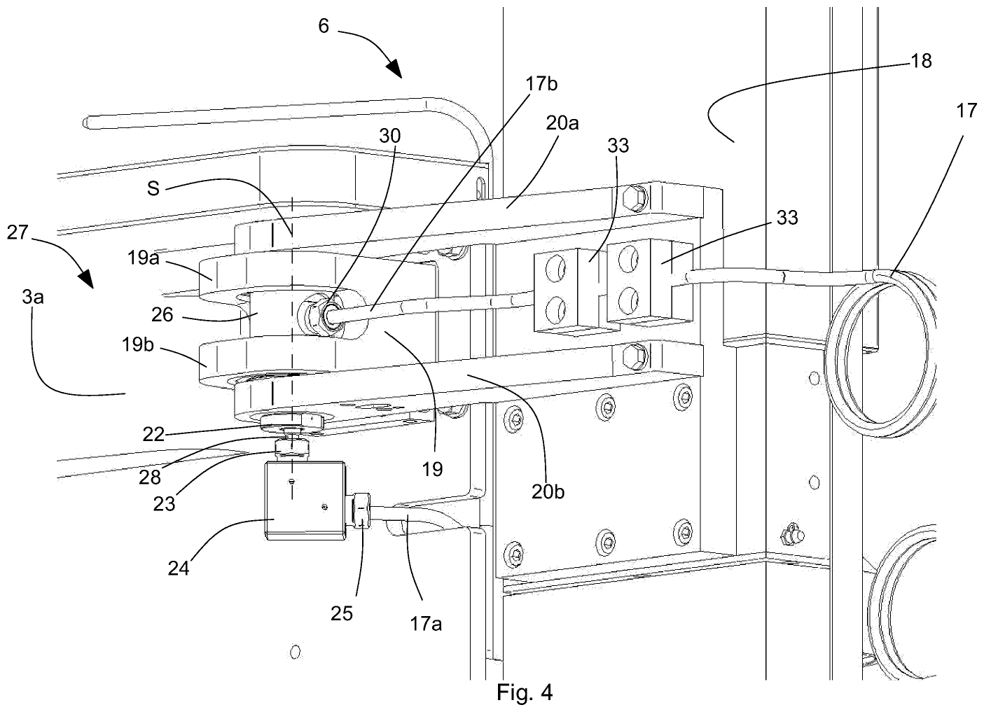

In a fitted configuration, an elongated portion 19a of the forked supporting bracket 19 is operationally positioned above another elongated portion 19b of the supporting bracket 19, as shown in FIG. 4.

On each elongated portion 19a, 19b a through hole is obtained; the two through holes have substantially the same diameter and have the same axis in common, this axis coinciding with the second axis of rotation S disclosed above.

The slide 18 is connected rotatably to the supporting bracket 19 by a connecting element 21, for example a pin. To be clear, the slide 18 is provided with at least one arm 20a, in particular with a pair of arms 20a and 20b that are substantially parallel to one another. One end of each arm can be connected removably to one face of the slide 18, for example by threaded connecting elements (screws, bolts or the like). The pair of arms can be fitted to one face of the slide 18 opposite the face to which the fluid jet cutting device 5 (in particular the cutting head 12) is fitted, to permit full freedom of movement to the fluid jet cutting device 5, for example a movement along the movement direction D.

In a further end of each arm 20a and 20b, in particular in the free end thereof, a through hole can be obtained. The two holes can have the same diameter.

The pair of arms 20a and 20b is connected rotatably to the supporting bracket 19, in particular to the elongated portion 19a, 19b by inserting the rotating connecting element 21. Before inserting the connecting element 21, it is necessary to position the arms with respect to the elongated portions so that the four holes, i.e. the two holes provided on the pair of arms 20a and 20b and the two holes provided on the pair of elongated portions 19a, 19b are substantially coaxial, i.e. aligned along the second axis of rotation S.

In the embodiment shown in FIG. 4 for example, the two arms 20a and 20b are fitted to the slide 18 such that they are spaced apart along a direction parallel to the second axis of rotation S, and so that the arm 20a is positioned above, and can contact, the elongated portion 19a of the supporting bracket 19, and the arm 20b is positioned below the elongated portion 19b of the supporting bracket 19.

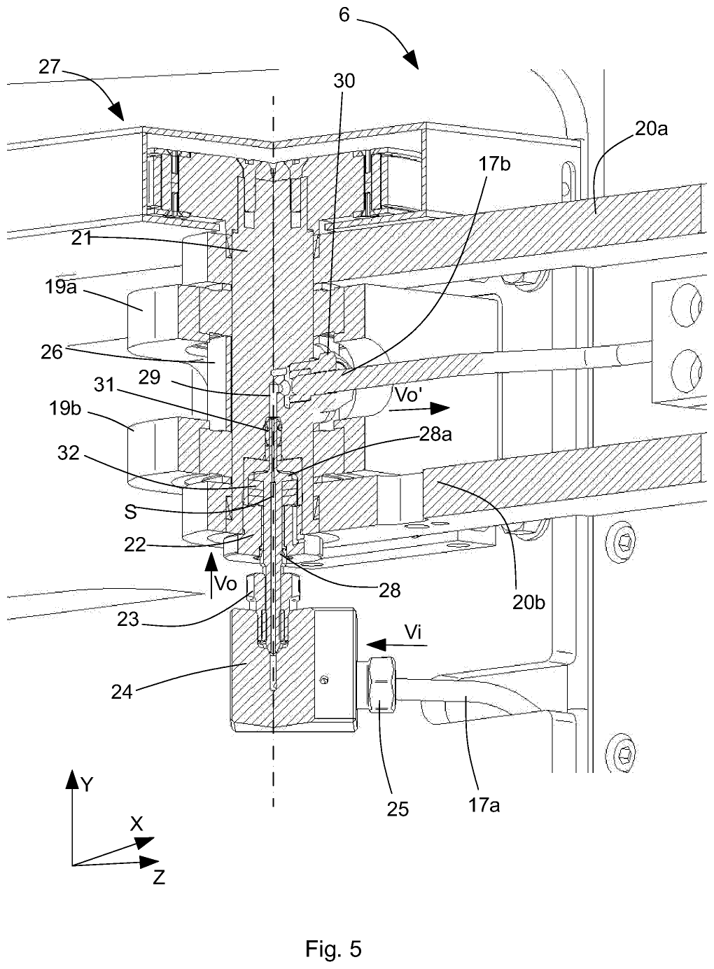

The rotating connecting element 21 is inserted between the four holes to make the arms 20a and 20b rotatable with respect to the elongated portions 19a and 19b around the second axis of rotation S. The connecting element 21 is further prevented from sliding along the second axis of rotation S. The connecting element 21 is rotatable around the second axis of rotation S. The connecting element 21 can be covered and protected by a hollow cylindrical casing 26, shown in FIGS. 4 and 5.

The handling device 6 is further connected to a motor, which is not shown, that is drivable to rotate the motor around the second axis of rotation S.

The fluid jet cutting device 5 is provided with a distributing assembly 27, shown in detail in FIGS. 4 and 5, arranged to distribute continuously a pressurized flowrate to the fluid jet cutting device 5 between the first and the second position, this second position being reached by the cutting device 5 after performing a rotation of about 180° from the first position.

The distributing assembly 27 is sized to be traversed by a fluid flowrate having pressure the same as or greater than four thousand bar. The distributing assembly 27 can be fitted to the handling device 6.

The distributing assembly can be integrated, at least partly, inside the connecting element 21. The distributing assembly 27 can be at least partly rotatable around the second axis of rotation S, as explained below.

The rotating distributing assembly 27 can include, in particular, at least one static or fixed first tube 28, and at least one second tube 29 connected rotatably to the first tube 28. The first tube 28 and the second tube 29 can be fitted, for example, so as to be coaxial between one another and so as to have an axis coinciding with the second axis of rotation S.

For example, the first tube 28 and the second tube 29 are housed inside the connecting element 21, in particular in a seat obtained in an end portion of the connecting element 21, as shown in FIG. 5. The second tube 29 is positioned operationally above the first tube 28, by observing FIG. 5 and considering the direction of the Y axis. The first tube 28 has dimensions that are such as to enable the first tube 28 to be inserted into the seat of the connecting element 21 without there being a contact between the walls thereof and those of the connecting element 21; in this manner the first tube 28 remains fixed to the connecting element 21.

At least one part of the first tube 28 is housed inside the seat obtained on the connecting element 21; as for example visible in FIG. 5, a part of the first tube 28 protrudes outside the seat of the first connecting element 21, to be inserted and housed in an inlet element 24, as will be explained below.

It is possible, as in this example, to arrange sealing elements 31, 32 (shown in FIG. 5) to make a seal between the first static tube 28 and the rotating connecting element 21. The sealing element 32 is for example fitted between the first tube 28 and the connecting element 21 and abuts against a shoulder 28a of the first tube 28.

The first tube 28 is locked in the movements along the second axis of rotation S by a locking element 22 inserted into the seat of the connecting element 21, for example a screw or a fixing bush. In particular, the locking element 22 acts on the sealing elements 32 to maintain in position the first tube 28.

The rotating distributing assembly 27 can include a static inlet element 24 provided with an inlet 25 connected to an inlet tube 17a to receive a pressurized pressurized fluid flowrate from the pressurized water generating device.

On the inlet element 24, a seat is obtained for housing the first tube 28; the first tube 28 is fixed to the inlet element by a fixing element 23, for example a fixing bush.

The first tube 28 is placed in fluid connection with the inlet 25, for example by obtaining a connecting conduit inside the inlet element 24. In the embodiment shown in FIG. 5 for example the connecting angle of the connecting conduit can be about 90°.

For greater clarity, with reference to FIG. 5, the pressurized fluid has a speed vector Vᵢ oriented substantially parallel to the plane defined by the axes X-Z in a section of the inlet 25, and a speed vector Vₒ in an inlet section of the first tube 28 oriented substantially upwards parallel to the Y axis. Supposing that the Y axis is parallel to and opposite the direction of the force of gravity, in the fitted configuration shown in FIG. 5, the pressurized fluid is provided with pressure that is such as to enable the pressurized fluid to traverse the first tube 28 by moving against the force of gravity.

In the same manner, passing into the second tube 29 the pressurized fluid moves against the force of gravity. The second tube 29 is further rotatable around the second axis of rotation S, following the rotation of the connecting element 21.

The rotation of the connecting element 21 can be substantially the same as the rotation imposed on the fluid jet cutting device 5, for example by an angle included between 90° and 200°, 120° and 200°, or included between 150° and 190°, in particular by an angle of 180° (in one rotation direction or in the opposite direction).

As a result, also the fluid that passes into the second tube 29 follows the rotations of the latter.

The distributing assembly 27 lastly includes an outlet 30 that connects the second tube 29 to an outlet tube 17b to enable the pressurized fluid to exit the distributing assembly and move to the fluid jet cutting device 5.

The pressurized fluid exiting the distributing assembly 27 has a speed vector Vₒ′ oriented substantially parallel to the plane defined by the axes X-Z in a section of the outlet 30.

In one embodiment that is not shown, the first tube and the second tube of the distributing assembly can both be rotatable, the first tube can be integral with the second tube during rotation. Obviously, in this case the first tube is also housed in the seat obtained on the inlet element but is rotatable in this seat (supporting elements can be provided, for example bearings arranged for supporting rotatingly the first tube).

Owing to the rotating distributing assembly 27 integrated in the connecting element 21, it is possible to transfer from a fixed structure (fluid pressure intensifier) to a movable structure (handling device 6 to which the cutting head 12 is fitted) simply and rapidly a fluid at high pressure, avoiding pressure reductions during rotation of the fluid jet cutting device 5.

The slide 18 is provided with one or more tube holders 33 arranged for fixing in position on the slide 18 the tubes 17, 17A, 17B and so on.

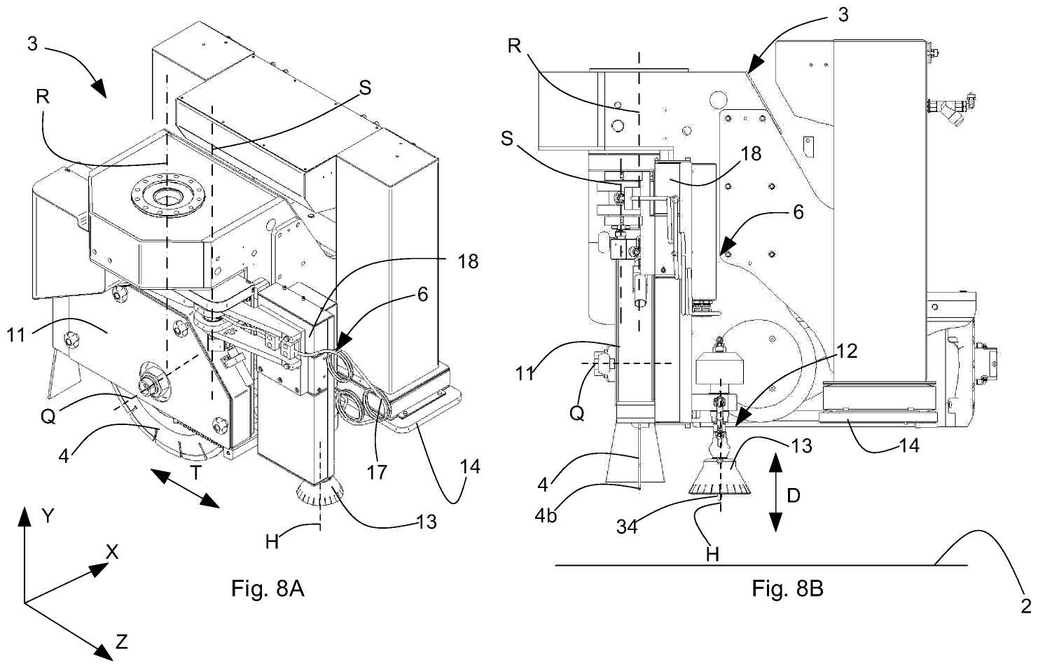

In use, as already disclosed previously, the handling device 6 is drivable to move the fluid jet cutting device 5 between a first position and a second position. With reference to FIGS. 7A and 7B, it is observed that the fluid jet cutting device 5 adopts a first position. In particular, the cutting head 12 is positioned in front of the cutting direction T of the cutting tool 4. In the first position of the fluid jet cutting device 5, the task of cutting the object can be performed by rotating only the cutting tool 4. In the first position, the fluid jet cutting device 5 can further adopt a raised position and a lowered position, illustrated in FIGS. 7B and 8B.

In the raised position, shown in FIG. 7B, the fluid jet cutting device 5, in particular the dispensing nozzle 34 of the cutting head 12, is substantially misaligned with the portion of the cutting edge 4b along a reference plane that is substantially parallel to the support plane 2.

In the raised position, the fluid jet cutting device 5, in particular the dispensing nozzle 34 of the cutting head 12, is substantially aligned with the portion of the cutting edge 4b along a reference plane that is substantially parallel to the support plane 2.

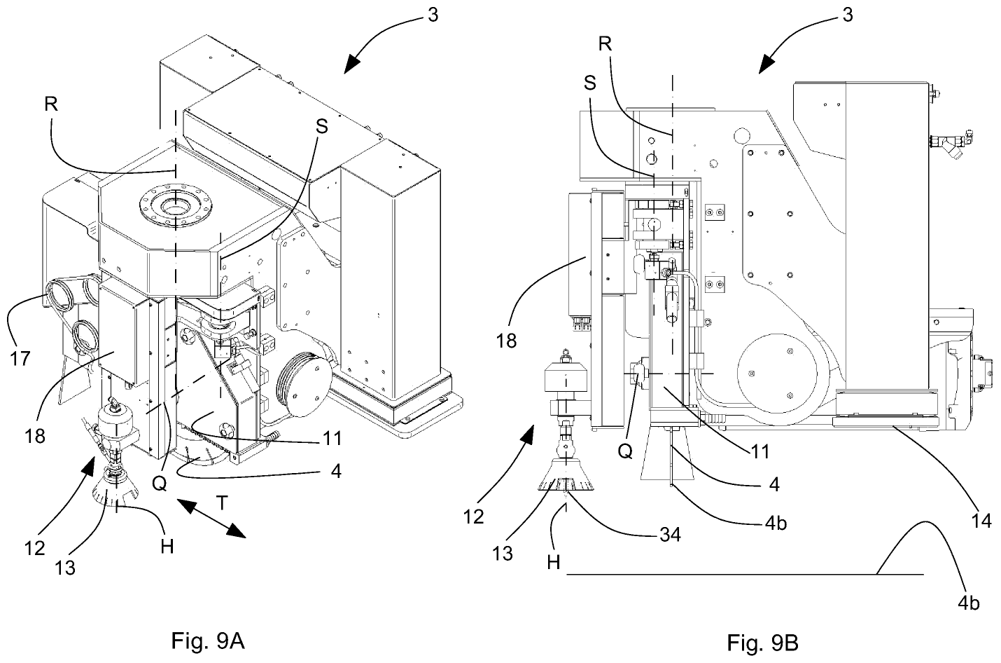

In use, the fluid jet cutting device 5 is taken from the raised position to the lowered position, for example by driving the actuating device and sliding the cutting head 12 along the guides obtained on the slide 18. In use, the handling device 6 is driven to take the fluid jet cutting device 5 from the first (lowered) position to the second position. The second position is for example shown in FIGS. 9A and 9B.

Owing to the invention, part of the movements of the fluid jet cutting device 5 are imposed by the machining unit 3, but another part of the movements are imposed by the handling device 6 that is drivable independently of the machining unit 3.

Advantageously, making the movements imposed on the fluid jet cutting device 5 (at least partially) independent with respect to the movement imposed on the fluid jet cutting device 5 by the machining unit 3 enables the overall dimensions and the distances between the cutting tool 4 and the fluid jet cutting device 5 to be reduced. The machining area, i.e. the area in which the fluid jet cutting device 5 can be driven to perform a cut on the object is moreover increased, and is autonomous of/independent fo/disconnected from the machining area in which the cutting device 4 performs the cutting task.

The machining unit 3 includes a static part, indicated with numeric reference 35, and a dynamic part, indicated with numeric reference 36.

The static part 35 is for example the part of the machining unit connected to the carriage 10; the dynamic part is for example the part of the machining unit in which the cutting tool 4, the fluid jet cutting device 5, the handling device 6, and so on are fitted.

The movable part 36 is rotable around a third axis of rotation K, oriented transversely to the first axis of rotation R and substantially parallel to the second axis Z. The movable part 36 is connected to a motor, non shown, which is drivable to rotate the movable part 36 around the third axis of rotation K.

The movable part 36 is rotated between a further first position in which the first axis of rotation R and the second axis of rotation S are substantially parallel, and a further second position in which the second axis of rotation S is transverse to the first axis of rotation R. In the further second position the first axis of rotation R coincides with the second axis of rotation S. The first axis of rotation R and the second axis of rotation S can form an angle of variable size, for example included between 0° and 95° between the further first and second position.

The movable part 36 is rotated to enable the cutting tool 4 and the fluid jet cutting device 5 to perform an oblique cutting task on the object. Also in this case, the fluid jet cutting device 5 is movable between the raised position and the lowered position (along a sliding direction), on the basis of the shape and dimensions of the surface/s of the object that has to be cut.

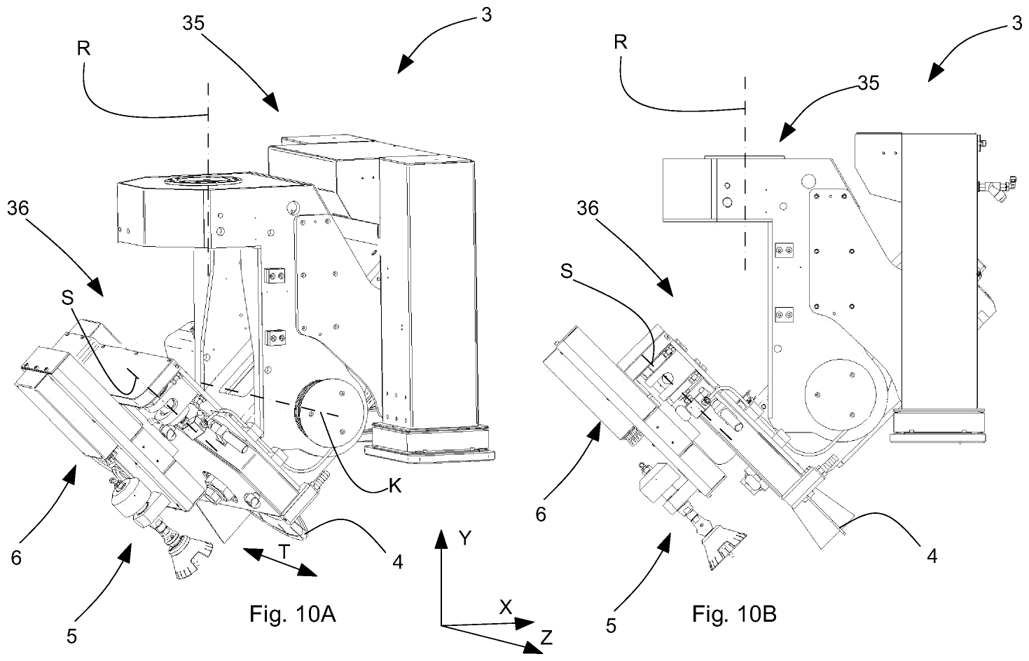

For example, in FIGS. 10A and 10B the fluid jet cutting device 5, in particular the cutting head 12, adopts a raised position, as disclosed above.

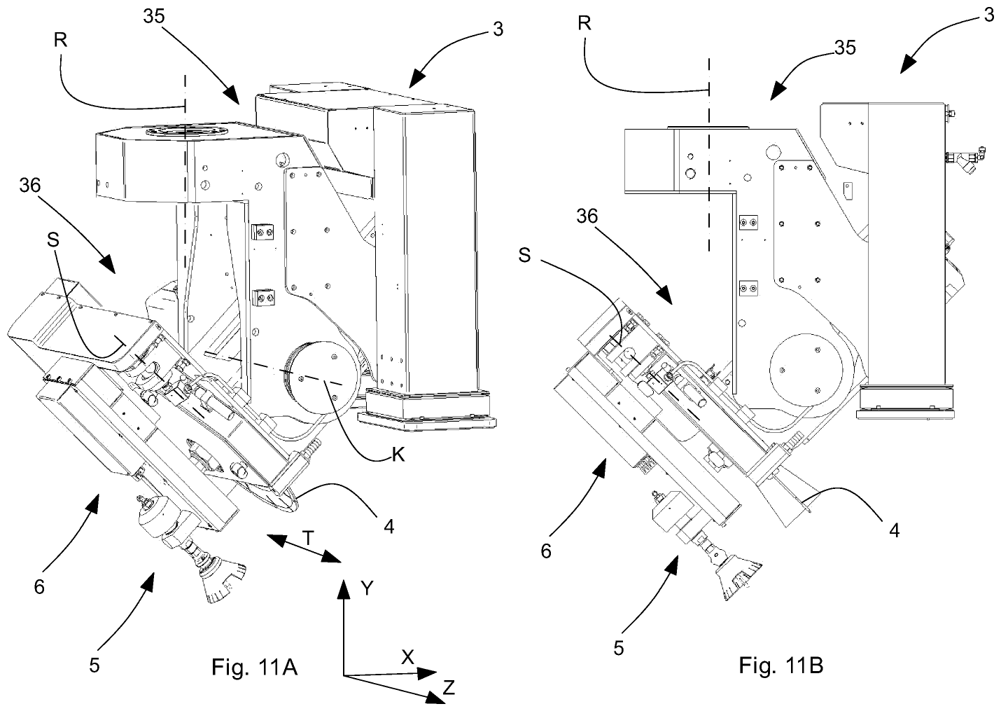

In FIGS. 11A and 11B, the fluid jet cutting device 5, in particular the cutting head 12, adopts a lowered position, as disclosed above.

The sliding direction, not shown in FIGS. 10A, 10B, 11A and 11B, along in this case substantially parallel to the second axis of rotation S, but is transverse to the first axis of rotation R.

It has been ascertained that owing to the (at least partly) independent movements of the fluid jet cutting device 5, the same advantages are obtained of reduction of the overall dimensions and distances between the cutting tool 4 and the fluid jet cutting device 5 and of increasing the machining area of the cutting device 5 also during execution of oblique cuts on the object. Further, owing to the movement of the fluid jet cutting device 5 between a lowered and raised position it is possible to approach the cutting head 12 tilted towards the object, to maintain the jet of fluid focused on the basis of the shapes of the object and to increase the maximum machinable thickness of the object.

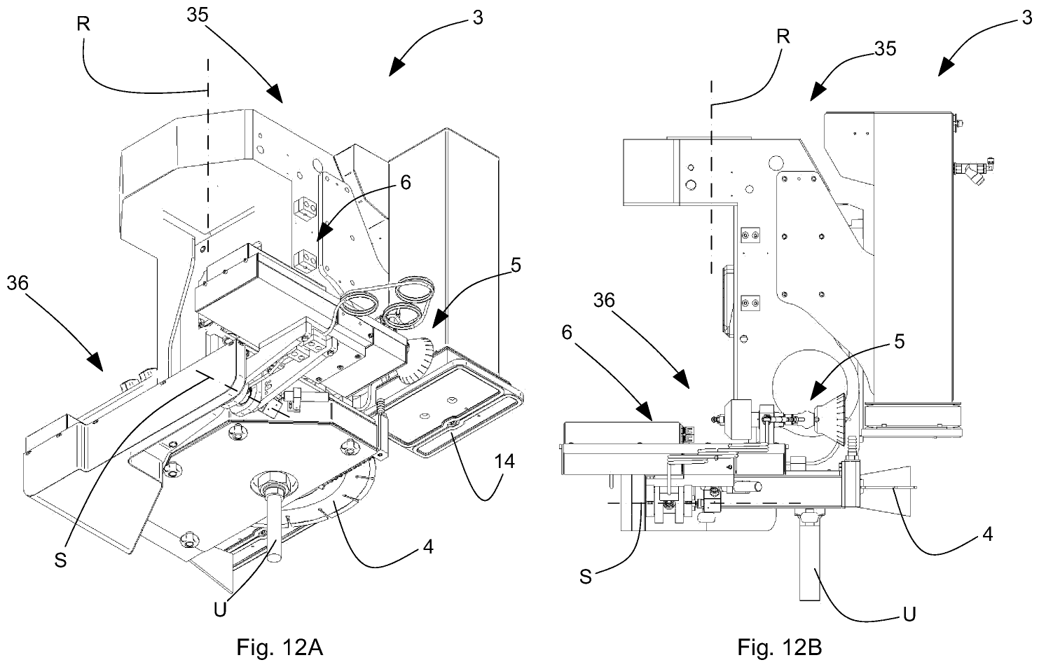

Lastly, positioning the fluid jet cutting device in the first position, outside the cutting area in which the cutting tool 4 operates, enables the machining centre to be adapted also to drilling and milling tasks, as shown for example in FIGS. 12A and 12B.

A drilling or milling tool U is for example fitted to the axis of rotation of the cutting tool 4. The movable part 36 adopts a further second position rotated by about 90° with respect to a further first position, i.e. the second axis of rotation S and the first axis of rotation R form an angle of about 90°. The fluid jet cutting tool can adopt the first or second position. Rotating the cutting tool 4 also rotates the tool U to perform milling or drilling tasks on the object.

1. A machining centre for cutting an object in the form of a slab, said machining centre including:
a support plane arranged to support said object;
a machining unit provided with a cutting tool which can be actuated in rotation for cutting said object and a fluid jet cutting device which can be actuated for cutting said object;
said machining unit being movable with respect to said support plane along a first axis, a second axis and a third axis of a triad of transversal axes to approach/remove said cutting tool and said fluid jet cutting device to/from said support plane, said machining unit being further rotatable about a first rotation axis to rotate said cutting tool and said fluid jet cutting device with respect to said support plane;
said machining unit being provided with a handling device arranged to support and to move said fluid jet cutting device with respect to said cutting tool along at least one direction transverse to said first rotation axis.

2. The machining centre of claim 1, wherein said handling device is arranged to move said fluid jet cutting device between a first position in which an operating axis of said fluid jet cutting device is placed at a first distance from a rotation axis of said cutting tool, and a second position in which said operating axis is placed at a second distance from said rotation axis, said second distance being lower than said first distance.

3. The machining centre of claim 2, wherein said handling device is arranged to rotate said fluid jet cutting device with respect to said cutting tool about a second rotation axis between said first position and said second position independently of a rotation given to said fluid jet cutting device by a rotation of said machining unit about said first rotation axis.

4. The machining centre of claim 3, wherein said handling device is arranged to rotate said fluid jet cutting device by an angle included between 90° and 200°, or between 120° and 200°, or between 150° and 190°, in particular by an angle of 180°.

5. The machining centre of claim 3, wherein said handling device includes a slide arranged to support said fluid jet cutting device, a supporting bracket arranged to support in rotation said slide about said second rotation axis, said slide being rotatably connected to said supporting bracket by means of a rotating connecting element so as to rotate about said second rotation axis.

6. The machining centre of claim 5, wherein said supporting bracket is detachably connected to a face of said machining unit, and said connecting element is rotatable about said second rotation axis.

7. The machining centre of claim 3, wherein said fluid jet cutting device is provided with a distributing assembly arranged to continuously distribute a pressure fluid to said fluid jet cutting device between said first position and second position, said distributing assembly being mounted on said handling device and being at least in part rotatable about said second rotation axis.

8. The machining centre of claim 6, wherein said fluid jet cutting device is provided with a distributing assembly arranged to continuously distribute a pressure fluid to said fluid jet cutting device between said first position and second position, said distributing assembly being mounted on said handling device and being at least in part rotatable about said second rotation axis, and wherein said distributing assembly is at least partially integrated within a seat obtained in said connecting element.

9. The machining centre of claim 7, wherein said distributing assembly includes at least one first tube that is static and extends parallel to said second rotation axis, and at least one second tube that is connected to said first tube and that is rotatable about said second rotation axis, said at least one first tube and said at least one second tube being arranged to be crossed by said pressure fluid between an inlet and an outlet of said distributing assembly, wherein a pressure of said pressure fluid is equal to, or greater than, 4000 bar.

10. The machining centre of claim 1, wherein said handling device is arranged to displace said fluid jet cutting device along a displacing direction to approach/remove said fluid jet cutting device to/from said object independently of an approaching/removing movement given to said fluid jet cutting device by a movement of said machining unit.

11. The machining centre of claim 1, wherein said machining unit includes at least one movable part rotatable about a third rotation axis substantially parallel to said second axis to allow said cutting tool and said fluid jet cutting device to perform tilted cutting operations on said object.

12. The machining centre of claim 3, wherein said machining unit includes at least one movable part rotatable about a third rotation axis substantially parallel to said second axis to allow said cutting tool and said fluid jet cutting device to perform tilted cutting operations on said object, and wherein said at least one movable part is connected to a motor which can be driven to rotate said at least one movable part between a further first position in which said first rotation axis and said second rotation axis are substantially parallel to each other, and a further second position in which said second rotation axis is tilted with respect to said first rotation axis, said first rotation axis and said second rotation axis between said further first and second position forming an angle of variable size included between 0° and 95°.
